(19) United States
(12) Patent Application Publication
(10) Pub. No.: US 2006/0126031 A1
(43) Pub. Date: Jun. 15, 2006

(54) Illumination optical system of projection apparatus

(75) Inventors: Sung-tae Kim, Seoul (KR); Jin-sik Kim, Suwon-si (KR); Jeong-ho Niio, Suwon-si (KR); Kee-uk Jeon, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/273,254

(22) Filed: Nov. 15, 2005

(30) Foreign Application Priority Data
Nov. 20, 2004 (KR) 10-2004-0095524

(51) Int. Cl. G03B 21/28

(52) U.S. Cl. 353/98

(57) ABSTRACT

An illumination optical system of a projection apparatus including a light source for emitting light, a light uniformity means shaped like a hexahedron, whose cross section becomes gradually larger from an input terminal to an output terminal and outputting uniform light through the output terminal when input with the light emitted from the light source through the input terminal, a light path changing means shaped like a plate and changing a path of the light output through the output terminal of the light uniformity means, and an image generator for receiving the light output through the light path changing means and generating an image. Thus, the present invention provides an illumination optical system of a projection apparatus for enhancing light uniformity and light segregation, and also providing easy fabrication and moderate cost.

### CROSS-REFERENCE TO RELATED APPLICATIONS

This application claims the benefit under 35 U.S.C. §119(a) of Korean Patent Application No. 10-2004-0095524, filed in the Korean Intellectual Property Office on Nov. 20, 2004, the entire disclosure of which is incorporated herein by reference.

### BACKGROUND OF THE INVENTION

1. Field of the Invention

The present invention relates to an illumination optical system of a projection apparatus. More particularly, the present invention relates to an illumination optical system of a projection apparatus for enhancing light uniformity and light segregation, and also providing easy fabrication and moderate cost.

2. Description of the Related Art

Recently, as demand for large-size and high definition display apparatus has increased, the use and implementation of a projection apparatus for enlarging and projecting a small picture through a projection lens has become widespread.

Such a projection apparatus is largely classified into categories including front projection apparatus and rear projection apparatus, according to a projection method employed therein.

The front projection apparatus projects an image signal in front of a screen and is generally used in a theater, a conference hall, and similar location. Meanwhile, the rear projection apparatus projects the image signal in back of the screen and is usually employed in a projection TV. Particularly, the rear projection apparatus displays a relatively bright picture even in light areas, thereby being more widely used than the front projection apparatus.

FIG. 1 illustrates an optical engine of a conventional projection apparatus which is disclosed in U.S. Pat. No. 6,129,437, the entire disclosure of which is incorporated herein by reference.

As shown therein, the optical engine of the conventional projection apparatus comprises an illumination optical system comprising a light source 100 for emitting light, an ellipsoidal mirror 102 for collecting the light emitted from the light source 100, a color wheel 104 for sequentially generating three colors of red (R), green (G), and blue (B), (or four colors of red (R), green (G), blue (B), and white (W)) from the light source 100, a light collecting lens 114 for collecting the light generated through the color wheel 104, a spherical mirror 116 for reflecting the light collected through the light collecting lens 114, a digital micromirror device (DMD) panel 106 modulated according to the light reflected by the spherical mirror 116 and generating a picture, and a projection optical system comprising a plurality of projection lenses 108a, 108b, 108c, and 108d for enlarging the picture generated by the DMD panel 106 and projecting it to a screen 110.

With this configuration, the light emitted from the light source 100 is reflected by the ellipsoidal mirror 102 and is concentrated on the color wheel 104. The color wheel 104 sequentially divides the concentrated light into the three colors of R, G, and B, (or the four colors of R, G, B, and W). The light sequentially divided by the color wheel 104 is then irradiated on the DMD panel 106 by the light collecting lens 114 and the spherical mirror 116. The light irradiated on the DMD panel 106 is modulated and enlargedly projected to the screen 110 through the projection lens 108. Here, the spherical mirror 116 decreases an incident angle of the light irradiated on the DMD panel 106, thereby improving light segregation.

However, the optical engine of the conventional projection apparatus is not appropriate for the rear projection apparatus, as a pivot axis of the DMD panel 106 and that of the projection lens 108 differ and the picture is deflectively displayed. Also, the spherical mirror 116 used to improve the light segregation is more expensive than a flat panel mirror, and the distribution of the light irradiated on the DMD panel 106 through the spherical mirror 116 triggers keystone distortion, thereby leading to poor light uniformity.

Accordingly, a light tunnel is disclosed in U.S. Pat. No. 5,625,738, the entire disclosure of which is incorporated herein by reference, as one means to make the light from the light source uniform.

The disclosed light tunnel comprises a reflection wall therein, and is tapered to make a cross section of an incident part and a cross section of an emitting part to be different from each other.

Generally, when the light of the light source comprising non-uniform light distribution is concentrated on the incident part of the light tunnel, multiple reflection occurs by the reflection wall inside the light tunnel, and light comprising uniform light distribution is emitted from the emitting part of the light tunnel, thereby decreasing an angle of the emitted light as compared with that of the incident light.

However, it is difficult to make each surface of the conventional light tunnel to be tapered, and attempts to do so increases costs.

Accordingly, a need exists for an illumination optical system of a projection apparatus for enhancing light uniformity and light segregation, and further providing easy fabrication and moderate cost.

### SUMMARY OF THE INVENTION

Accordingly, it is an aspect of the present invention to solve the above and other problems associated with the conventional devices and provide an illumination optical system of a projection apparatus for enhancing light uniformity and light segregation, and also providing easy fabrication and moderate cost.

Additional aspects and advantages of the invention will be set forth in part in the description which follows and, in part, will be obvious from the description or may be learned by the practice of the invention.

The foregoing and other aspects of the present invention are achieved by providing an illumination optical system of a projection apparatus comprising a light source for emitting light, a light uniformity means substantially shaped like a hexahedron whose cross section becomes gradually larger from an input terminal to an output terminal and outputting uniform light through the output terminal when input with the light emitted from the light source through the input terminal, a light path changing means substantially shaped like a plate and changing a path of the light output through the output terminal of the light uniformity means, and an image generator for receiving the light output through the light path changing means and generating an image.

According to an aspect of the present invention, the light uniformity means comprises a hollow light tunnel comprising a plurality of internal reflection surfaces for reflecting the light input through the input terminal and outputting it through the output terminal.

According to an aspect of the present invention, among the plurality of reflection surfaces of the light uniformity means, a pair of reflection surfaces facing each other become larger in size along a lengthwise direction, and a remaining pair of reflection surfaces are substantially identical in size along the lengthwise direction.

According to an aspect of the present invention, the light uniformity means comprises a glass rod comprising a plurality of reflection surfaces for reflecting the light input through the input terminal and outputting it through the output terminal of the light uniformity means.

According to an aspect of the present invention, the illumination optical system of the projection apparatus further comprises at least one light collecting lens for collecting the light output through the output terminal of the light uniformity means and irradiating it on the light path changing means.

According to an aspect of the present invention, the image generator comprises a digital micromirror device (DMD) panel arrayed as a plurality of minute mirrors that can each be rotated around a predetermined rotation axis, generating “on/off” states along a rotation direction of the minute mirrors when the respective minute mirrors receive the light from the light path changing means.

According to an aspect of the present invention, the lengthwise direction of the light uniformity means and the lengthwise direction of the image generator are disposed in parallel such that the rotation direction of the image generator conforms to the lengthwise direction thereof.

According to an aspect of the present invention, the light output from the light uniformity means is incident to the rotation direction of the image generator.

According to an aspect of the present invention, the illumination optical system of the projection apparatus further comprises a color divider for dividing the light emitted from the light source into a plurality of colors and outputting the divided light to the light uniformity means.

According to an aspect of the present invention, the illumination optical system of the projection apparatus further comprises an ultraviolet blocking filter for blocking ultraviolet rays among the light emitted from the light source and outputting the filtered light to the color divider.

According to an aspect of the present invention, the light path changing means comprises a flat panel mirror.

### BRIEF DESCRIPTION OF THE DRAWINGS

The above and other aspects and advantages of the present invention will become more apparent and readily appreciated from the following description of exemplary embodiments taken in conjunction with the accompany drawings, of which:

FIG. 1 illustrates a configuration of an optical engine of a conventional projection apparatus;

FIG. 2 illustrates a configuration of an optical engine of a projection apparatus according to an embodiment of the present invention;

FIG. 3a is a perspective view of a light tunnel according to an embodiment of the present invention;

FIG. 3b is a sectional view taken along a lengthwise direction of the light tunnel in FIG. 3a;

FIG. 3c is a sectional view taken along a transverse direction of the light tunnel in FIG. 3a;

FIGS. 4a and 4b illustrate angle distribution of an incident light and an emitted light of the light tunnel in FIG. 3a, respectively;

FIGS. 5 and 6 illustrate an operation of a digital micromirror device (DMD) panel in FIG. 2 according to an embodiment of the present invention;

FIG. 7a illustrates a path of light being incident to a projection lens when a light uniformity means according to an embodiment of the present invention is not applied thereto; and

FIG. 7b illustrates a path of light being incident to the projection lens when the light uniformity means according to an embodiment of the present invention is applied thereto.

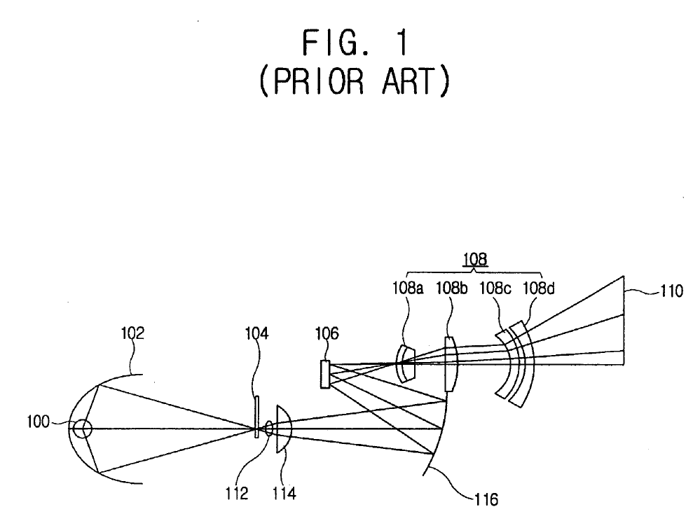

Throughout the drawings, like reference numerals will be understood to refer to like parts, components and structures.

### DETAILED DESCRIPTION OF THE EXEMPLARY EMBODIMENTS

Reference will now be made in detail to embodiments of the present invention, examples of which are illustrated in the accompanying drawings, wherein like reference numerals refer to like elements throughout.

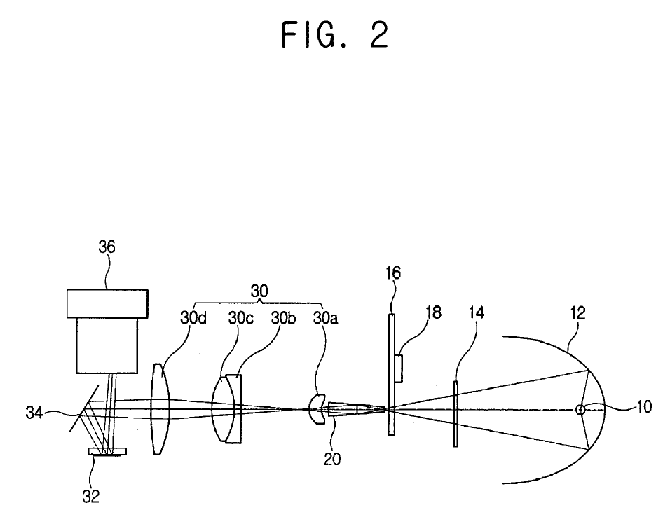

FIG. 2 illustrates a configuration of an optical engine comprising an illumination optical system of a projection apparatus according to an embodiment of the present invention.

As shown therein, the illumination optical system comprises a light source 10 for emitting light, an ellipsoidal mirror 12 for collecting the light emitted from the light source 10, a color wheel 16 rotated by a color wheel driver 18 and sequentially generating three colors of red (R), green (G), and blue (B), (or four colors of red (R), green (G), blue (B), and white (W)) from the light, a light uniformity means 20 for making the light generated through the color wheel 16 uniform, at least one light collecting lens 30 for collecting the light emitted from the light uniformity means 20, a flat panel mirror 34 for changing a path of the light collected through the light collecting lens 30, and a digital micromirror device (DMD) panel 32 for modulating the light having the path changed by the flat panel mirror 34 and generating a picture. The illumination optical system further comprises a projection optical system comprising a projection lens 36 for enlarging the picture generated by the DMD panel 32 and projecting it to a screen (not shown). Also, the illumination optical system may further comprise an ultraviolet blocking filter 14 for blocking ultraviolet rays among the light collected from the ellipsoidal mirror 12.

The light source 10 emits white light made up of a plurality of single-colored lights, that is, red (R), green (G), and blue (B), each having a different wavelength. A laser, mercurial lamp, metal halide lamp, halogen lamp, xenon lamp, and the like, can be used as the light source 10.

The color wheel 16 is rotated by the color wheel driver 18 and is divided into areas of R, G, and B. The white light emitted from the light source 10 is sequentially divided into the single colors of R, G, and B by the areas of R, G, and B of the color wheel 16. Each area of the color wheel 16 is color-coated to selectively transmit the respective single-colored lights, and transmits the single-colored lights corresponding to the respective areas.

The light uniformity means 20 is substantially shaped like a hexahedron whose cross section becomes larger from an input terminal to an output terminal, and changes the single-colored lights transmitted by the color wheel 16 into a rectangular beam having a predetermined aspect ratio. Such a light uniformity means 20 is preferably an empty light tunnel or a glass rod filled with transparent material, but is not limited thereto.

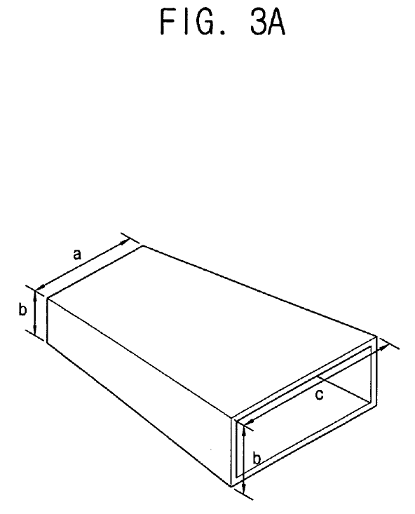

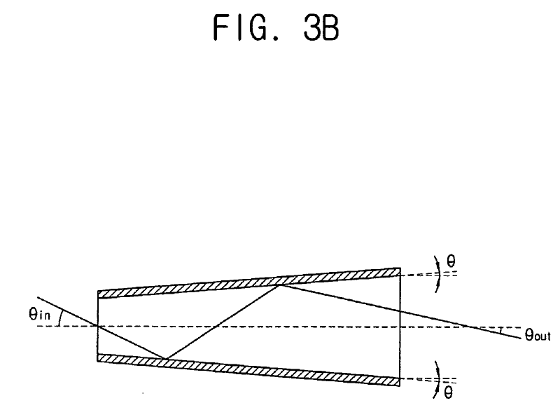

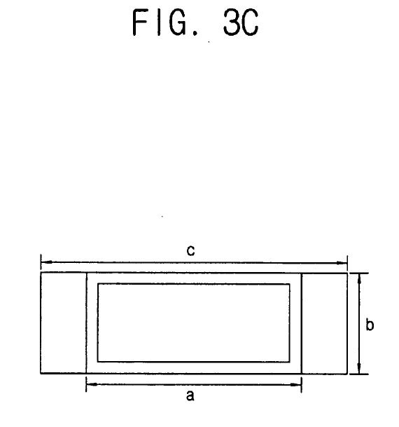

FIG. 3a is a perspective view of an exemplary light tunnel of the light uniformity means 20, FIG. 3b is a sectional view taken along a lengthwise direction of the light tunnel in FIG. 3a, and FIG. 3c is a sectional view taken along a transverse direction of the light tunnel in FIG. 3a.

As shown in FIG. 3a, the light tunnel is substantially shaped like an empty hexahedron, and comprises four reflection surfaces therein. Among the four reflection surfaces, an upper reflection surface and a lower reflection surface facing each other are tapered, and the remaining two side reflection surfaces facing each other are substantially shaped like a rectangle.

As shown in FIGS. 3a and 3c, the upper and lower reflection surfaces become larger from (a) to (c) along the lengthwise direction, and the two side reflection surfaces comprise a uniform size (b) along the lengthwise direction.

Such a light tunnel is fabricated more easily and costs less than a conventional light tunnel, wherein all of the respective surfaces are tapered.

FIG. 3b is a sectional view taken along the lengthwise direction of the light tunnel in FIG. 3a. As shown therein, an edge of the upper and lower reflection surfaces is tapered along a predetermined angle θ in the lengthwise direction. Thus, an angle θₒᵤₜ of the light emitted from the output terminal of the light tunnel becomes smaller than an angle θᵢₙ of the light being incident through the input terminal thereof.

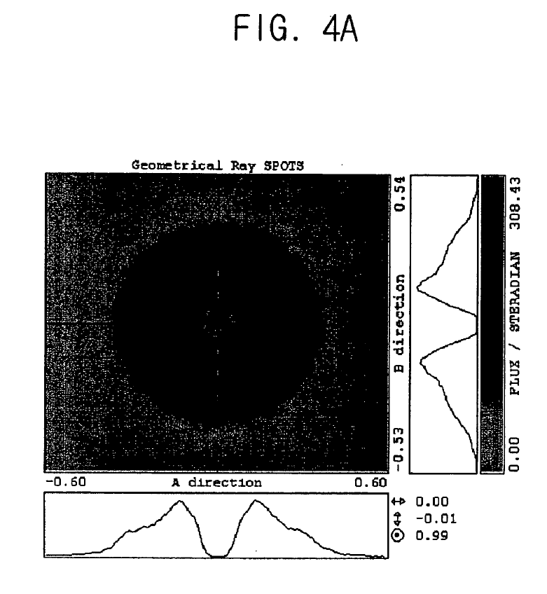

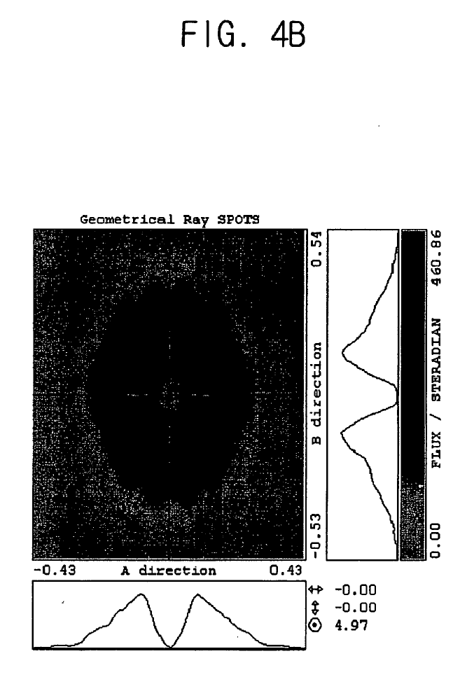

FIGS. 4a and 4b illustrate the angle distribution of the incident light and the emitted light being simulated after allowing the light of the light source 10, collected by the ellipsoidal mirror 12, to be incident to the input terminal of the light tunnel of the light uniformity means 20.

As shown in FIG. 4a, the incident light of the light tunnel is collected in all directions , that is, collected over 360 degrees, in an identical angle distribution (shaped like a cone). Meanwhile, as shown in FIG. 4b, the emitted light shape is decreased by the tapered direction of the light tunnel (the lengthwise direction of the light tunnel), in a direction “A” as shown in FIG. 4b by as much as a predetermined angle.

Returning to FIG. 2, the light collecting lens 30 collects the light emitted from the light uniformity means 20 and outputs the collected light to the flat panel mirror 34. The light collecting lens 30 is provided as one or more lenses, and is comprised of four lenses 30a, 30b, 30c, and 30d in the embodiment shown in FIG. 2, but is not limited thereto. Accordingly, the number of the light collecting lens may differ according to the specification of a system and the determination of a designer. Preferably, three to five light collecting lenses are provided.

The flat panel mirror 34 is inclined at a predetermined angle to allow the light irradiated on the DMD panel 32 to be incident to the projection lens 36 when in the “on” state, while considering the incident angle of the light being incident from the light collecting lens 30. The single-colored lights being incident to the flat panel mirror 34 are reflected to a plurality of minute mirrors 42 of the DMD panel 32.

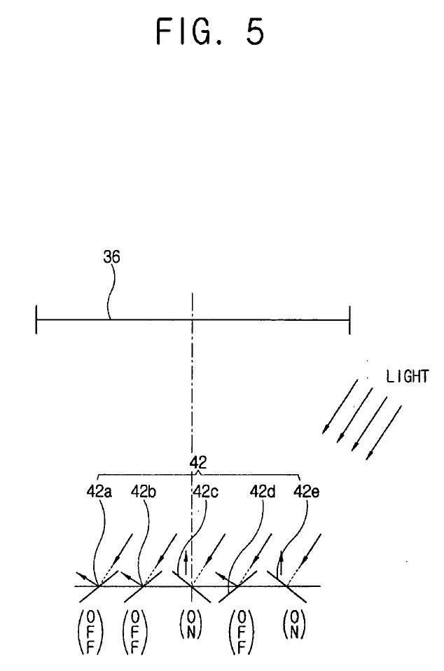

The DMD panel 32 is formed as a planar array (that is, a two dimensional array) of a plurality of minute mirrors 42 that can each be rotated about an individual axis. As shown in FIG. 5, the respective minute mirrors 42a, 42b, 42c, 42d, and 42e, can each generate an “on” state to receive the light reflected from the flat panel mirror 34 along a rotation direction and direct it to be incident to the projection lens 36, and an “off” state to receive the light reflected from the flat panel mirror 34 and direct it such that it is not incident to the projection lens 36.

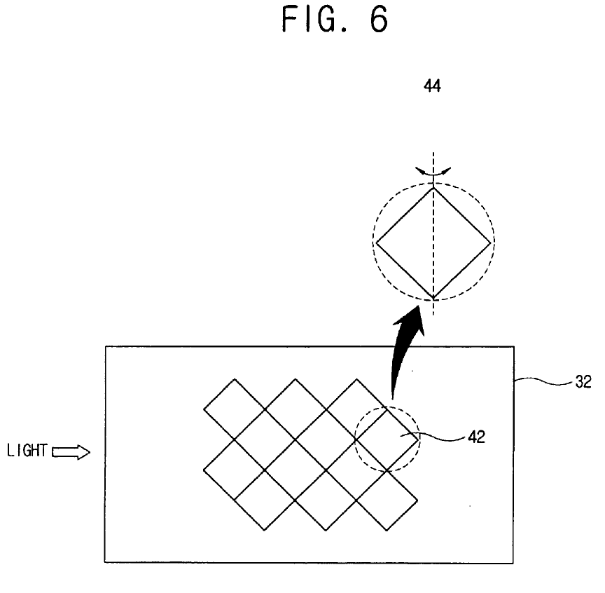

As shown in FIG. 6, if the rotation direction about a rotation axis 44 of the respective minute mirrors 42 is positioned to be in the lengthwise direction of the DMD panel 32, it is preferable but not necessary to make the light emitted from the light uniformity means 20 to be incident in the rotation direction of the DMD panel 32 by disposing the light uniformity means 20 along the lengthwise direction of the DMD panel 32. Accordingly, the light segregation of the incident light and the reflected light of the DMD panel 32 is improved due to an angle decrease of the incident light output from the light uniformity means 20 to the rotation direction of the DMD panel 32.

The projection lens 36 enlarges the light reflected in the “on” state by the minute mirrors 42 of the DMD panel 32 and projects it to the screen (not shown).

With this configuration, the light emitted from the light source 10 is reflected by the ellipsoidal mirror 12 and concentrated on the color wheel 16. The color wheel 16 sequentially divides the collected light into the three colors of R, G, and B, (or the four colors of R, G B, and W). The light sequentially divided by the color wheel 16 is then changed into the uniform rectangular light by the multiple reflections within the light uniformity means 20, and is then emitted to the light collecting lens 30. The emerging light is irradiated on the DMD panel 32 by the light collecting lens 30 and the flat panel mirror 34. The light irradiated on the DMD panel 32 is modulated and enlargedly projected to the screen (not shown) through the projection lens 36.

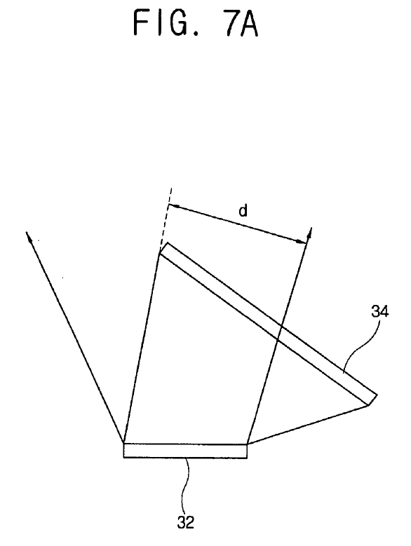

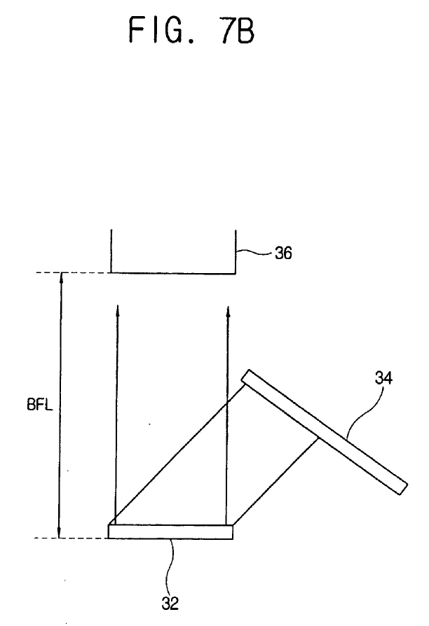

FIG. 7a illustrates a path of the light irradiated on the DMD panel 32 through the flat panel mirror 34 and being incident to the projection lens 36 when not applying the light uniformity means 20 according to an embodiment of the present invention. FIG. 7b illustrates a path of the light irradiated on the DMD panel 32 through the flat panel mirror 34 and being incident to the projection lens 36 when applying the light uniformity means 20 according to an embodiment of the present invention.

As shown in FIG. 7a, when not applying the light uniformity means 20, light loss occurs by as much as an area “d”. Conversely, when the light having a decreased emerging angle is reflected through the flat panel mirror 34 and irradiated on the DMD panel 32 by applying the light uniformity means 20, the light loss shown in FIG. 7a does not occur. Thus, the light segregation is enhanced, and light efficiency and contrast of the picture is also improved. Also, a back focal length (BFL) of the projection lens 36 becomes shorter, thereby allowing the design and fabrication of the projection lens 36 without difficulty and with reduced costs.

As described above, the present invention employs the light uniformity means and the flat panel mirror, which can be fabricated without difficulty and with reduced costs to replace the conventional spherical mirror, thereby enhancing the light uniformity and the light segregation.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An illumination optical system of a projection apparatus, comprising:
a light source for emitting light;
a light uniformity means comprising an input terminal, an output terminal, and a body therebetween, wherein the body is substantially shaped like a hexahedron and comprises a cross section area that becomes larger from the input terminal to the output terminal, and which is configured to output uniform light through the output terminal when input with the light emitted from the light source through the input terminal;
a light path changing means substantially shaped like a plate for changing a path of the light output through the output terminal of the light uniformity means; and
an image generator for receiving the light output through the light path changing means and generating an image.

2. The illumination optical system of the projection apparatus according to claim 1, wherein the light uniformity means comprises:
a substantially hollow light tunnel comprising a plurality of internal reflection surfaces for reflecting the light input through the input terminal and outputting the light through the output terminal.

3. The illumination optical system of the projection apparatus according to claim 2, wherein the plurality of reflection surfaces of the light uniformity means comprises:
a pair of reflection surfaces facing each other and which are configured to become larger in size along a lengthwise direction; and
a remaining pair of reflection surfaces which are configured to remain substantially identical in size along the lengthwise direction.

4. The illumination optical system of the projection apparatus according to claim 1, wherein the light uniformity means comprises:
a glass rod comprising a plurality of reflection surfaces for reflecting the light input through the input terminal and outputting the light through the output terminal.

5. The illumination optical system of the projection apparatus according to claim 4, wherein the plurality of reflection surfaces of the light uniformity means comprises:
a pair of reflection surfaces facing each other and which are configured to become larger in size along a lengthwise direction; and
a remaining pair of reflection surfaces which are configured to remain substantially identical in size along the lengthwise direction.

6. The illumination optical system of the projection apparatus according to claim 1, further comprising:
at least one light collecting lens for collecting the light output through the output terminal of the light uniformity means and irradiating the light on the light path changing means.

7. The illumination optical system of the projection apparatus according to claim 1, wherein the image generator comprises:
a digital micromirror device (DMD) panel comprising an array of minute mirrors configured to be rotated around a predetermined rotation axis for generating at least one of an “on” and “off” state along a rotation direction of the minute mirrors when the respective minute mirrors receive the light from the light path changing means.

8. The illumination optical system of the projection apparatus according to claim 7, wherein the lengthwise direction of the light uniformity means and the lengthwise direction of the image generator are disposed in parallel such that the rotation direction of the image generator conforms to the lengthwise direction thereof.

9. The illumination optical system of the projection apparatus according to claim 8, wherein the light output from the light uniformity means is incident to the rotation direction of the image generator.

10. The illumination optical system of the projection apparatus according to claim 1, further comprising:
a color divider for dividing the light emitted from the light source into a plurality of colors and outputting the divided light to the light uniformity means.

11. The illumination optical system of the projection apparatus according to claim 10, further comprising:
an ultraviolet blocking filter for blocking ultraviolet rays among the light emitted from the light source and outputting the filtered light to the color divider.

12. The illumination optical system of the projection apparatus according to claim 1, wherein the light path changing means comprises a flat panel mirror.

13. A method for providing an illumination optical system for enhancing light uniformity and light segregation, comprising the steps of:
emitting a light from a light source;
directing the emitted light through a light uniformity means comprising a plurality of internal reflection surfaces for reflecting the light input through an input terminal and outputting the light through an output terminal such that an angle θₒᵤₜ of the light emitted from the output terminal of the light uniformity means becomes smaller than an angle θᵢₙ of the light incident through the input terminal of the light uniformity means; and
changing a path of the light output from the light uniformity means and generating an image.

14. The method for providing an illumination optical system according to claim 13, wherein the plurality of reflection surfaces of the light uniformity means comprise a pair of reflection surfaces facing each other and which become larger in size along a lengthwise direction, and a remaining pair of reflection surfaces which remain substantially identical in size along the lengthwise direction.

15. The method for providing an illumination optical system according to claim 13, further comprising the step of:
collecting the light output through the output terminal of the light uniformity means and irradiating it on a light path changing means.

16. The method for providing an illumination optical system according to claim 15, further comprising the step of:
providing a digital micromirror device (DMD) panel comprising a plurality of minute mirrors that can each be rotated around a predetermined rotation axis for generating at least one of an “on” and “off” state along a rotation direction of the minute mirrors when the respective minute mirrors receive the light from the light path changing means.

17. The method for providing an illumination optical system according to claim 13, further comprising the step of dividing the light emitted from the light source into a plurality of colors and outputting the divided light to the light uniformity means.

18. The method for providing an illumination optical system according to claim 13, further comprising the step of blocking ultraviolet rays among the light emitted from the light source.
